(19) United States
(12) Patent Application Publication
(10) Pub. No.: US 2003/0156930 A1
(43) Pub. Date: Aug. 21, 2003

(54) Vehicle article carrier

(76) Inventor: Artie A. Ahedo JR., Tampa, FL (US)

Correspondence Address: William M. Hanlon, Young & Basile, P.C., Suite 624, 3001 West Big Beaver Road, Troy, MI, 48084, US

(21) Appl. No.: 10/080,133

(22) Filed: Feb. 21, 2002

(51) Int. Cl. B60P 9/00

(52) U.S. Cl. 414/462; 224/521; 414/540

(57) ABSTRACT

An article carrier for a vehicle is attachable to a rear mounted vehicle attachment, such as an elevatable lift attachment. The article carrier includes a tray having at least one article receiving track mounted therein for receiving an article. The tray is affixable to the vehicle attachment. A cover is movably mounted on the tray for movement between a first closed position enclosing the tray and an article mounted thereon and a second, open position wherein the cover is spaced from the tray to expose substantially all of the tray for article loading and unloading. Article tie-downs are carried on the tray for securing an article mounted on the tray in a fixed, stationary position. Latches are provided on the cover and the tray for releasably latching the cover in the first closed position.

### BACKGROUND OF THE INVENTION

The present invention relates, in general, to vehicle article carriers, and more particularly, to article carriers which are mounted on a vehicle for carrying human transport vehicles.

It is known to provide vehicles, such as automobiles, with article carriers for transporting diverse articles exteriorly of the vehicle passenger compartment and the vehicle truck. For example, vehicle luggage racks or article carriers have been mounted on the roofs of vehicles for carrying skis, luggage carriers, etc. Bicycle and wheelchair racks have been mounted to the rear frame of the vehicle for carrying bicycles and wheelchairs on the rear end of vehicles.

It is also known to provide vehicles with a trailer hitch which is attached to vehicle frame structure to allow a trailer to be attached to and towed from the rear of the vehicle. Such trailer hitch attachments have also been employed with specially designed carriers for carrying wheelchairs, bikes and the like. Such carriers typically have a closed, multi-sided enclosure and have at least one pivotal panel which may coact as a door, and which can be pivoted downward for use as a loading and unloading ramp.

While such article carriers have proven effective in transporting the articles for which they are specifically designed, the article carriers designed for wheelchairs and the like typically receive the wheelchair in a rolled in condition without any thought of a tie downs to prevent the wheelchair from shifting during movement of the vehicle, particularly during vehicle turns. Such carriers for wheelchairs also provide only a single opening, typically to one side of the carrier, to allow a wheelchair in a folded up condition to be rolled into and out of the carrier enclosure. The single access panel on one side of such enclosure limits access to the interior of the enclosure and makes any use of tie down straps to fixedly and stationarily position the wheelchair in the carrier difficult to implement.

Thus, it would be desirable to provide an article carrier for vehicles which is capable of easy attachment to a vehicle rear trailer hitch, is weather resistance to protect the enclosed articles from the environment, and is capable of latching or tying down the article within the enclosure in a fixed stationary position during movement of the vehicle.

### SUMMARY OF THE INVENTION

The present invention is an article carrier for mounting on a rear vehicle trailer mount. The article carrier is configured for easily carrying diverse articles, such as wheelchairs, bicycles, strollers, motorcycles and other human transport vehicles.

In one aspect, the article carrier includes:

an article carrier mountable on a rear vehicle attachment, the article carrier comprising:

an enclosure for receiving an article, the enclosure including:

a tray adapted to be mounted on the vehicle attachment, the tray formed of a bottom wall having a one side edge; and

a cover movably attached to the tray, the cover formed of a closed body completely covering the tray when in a first closed position and movable to a second position exposing substantially the entire bottom wall of the enclosure for article loading and unloading into and out of the tray.

In another aspect, the article carrier includes:

an article carrier mountable on a rear vehicle attachment, the article carrier comprising:

an enclosure for receiving an article, the enclosure including:

a tray adapted to be mounted on the vehicle attachment, the tray formed of a bottom wall having a one side edge;

a cover movably attached to the tray, the cover formed of a closed body completely covering the tray when in a first closed position and movable to a second position exposing substantially the entire bottom wall of the enclosure for article loading and unloading into and out of the tray;

the vehicle attachment including an elevatable lift portion connectable to the tray and enabling elevational movement of the enclosure relative to the vehicle between a first raised position and a second lowered, article loading and unloading position.

The present vehicle article carrier is easily mountable to a rear attached, elevatable vehicle lift thereby enabling the article carrier to be easily elevated or lowered between a raised, vehicle movement position and a lowered article loading and unloading position. The enclosure completely surrounds the article stored therein and is formed of weather resistant materials for long term use. The article carrier is uniquely provided with tie downs which latch the article in a stationary position within the carrier during movement of the vehicle.

### BRIEF DESCRIPTION OF THE DRAWINGS

The various features, advantages and other uses of the present invention will become more apparent by referring to the following detailed description and drawing in which:

FIG. 1 is a perspective view of a vehicle article carrier according to the present invention shown in an elevated position on a vehicle;

FIG. 2 is a side perspective view showing the vehicle lift attachment on the article carrier shown in FIG. 1;

FIG. 3 is a perspective view of the article carrier shown in FIGS. 1 and 2, but depicted in a lowered article loading and unloading position, with the cover deployed an open position;

FIG. 4 is a perspective view of the tray of the article carrier of the present invention; and

FIG. 5 is a perspective view showing the positioning and latching of a wheelchair in the tray of the article carrier of the present invention.

### DETAILED DESCRIPTION

Referring now to FIGS. 1-5 of the drawing, there is depicted a vehicle article carrier 10 constructing in accordance with the teachings of the present invention. The vehicle article carrier 10 includes an enclosure 12 which is mountable on a vehicle attachment 14 which can be fixedly mounted to the rear structure of the vehicle, such as to a trailer hitch 17 mounted to the vehicle frame below the rear bumper 16.

The enclosure 12 is configured of a size and shape for receiving many diverse articles. Thus, it will be understood that the enclosure 12 can receive many different articles, not just the human transport vehicles, such as a manually operated, collapsible wheelchair or a powered wheelchair which is described and illustrated hereafter. For example, in addition to wheelchairs, the enclosure 12 can be modified in size to handle a two wheel, gyroscopically stabilized human transport sold by Segway. Other articles which can be mounted in the enclosure 12 include motor cycles, bicycles, strollers, baby carriages, etc.

The enclosure 12 is formed of a cover 20 and a bottom portion or tray 22. It will be understood that the following description of the cover 20 and tray 22 as having a polygonal or rectangular shape is by way of example only as other shapes, such as polygonal shapes having more than four sides, ovals, etc., may also be employed.

Both the cover 20 and the tray 22 are formed of a suitable weather resistant material, such as plastic. Coated, treated or corrosion resistant metals may also be employed, such as aluminum, coated or galvanized steel, etc.

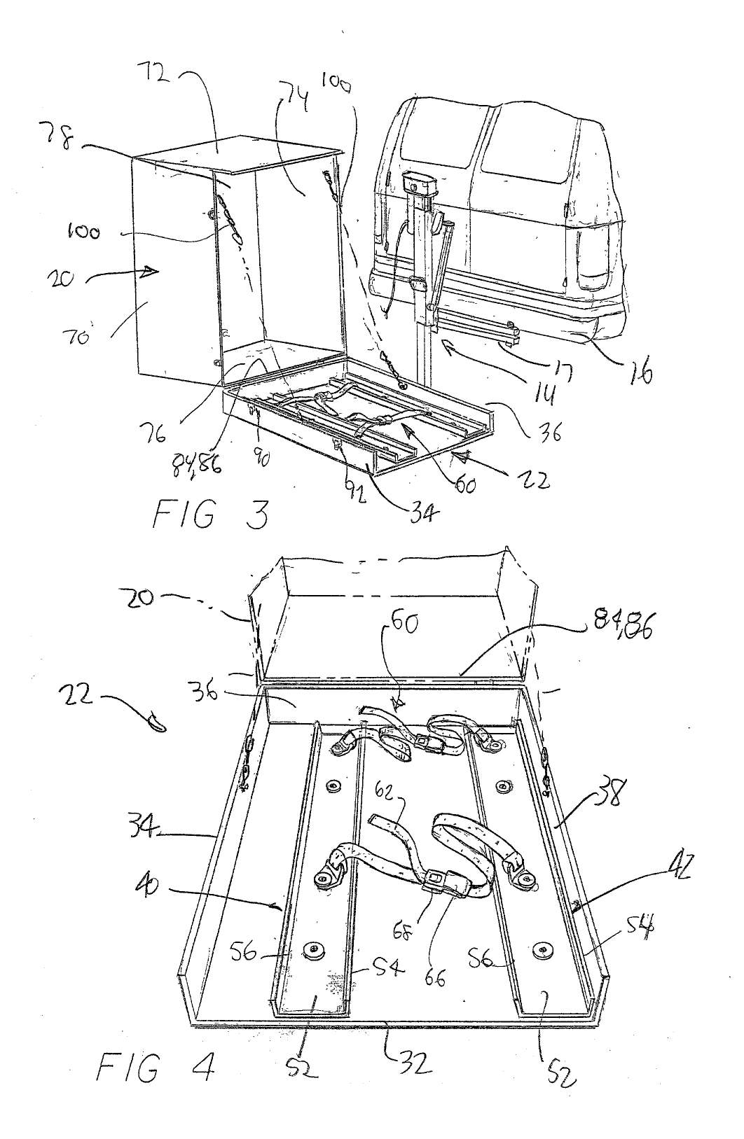

As shown in greater detail in FIGS. 3-5, the tray 22 is formed with a generally planar bottom wall 30 having an open side edge 32. The remaining three sides of the bottom wall 30 have angularly disposed sidewalls 34, 36 and 38 projecting generally perpendicularly therefrom to form a three sided wall along the other three side edges of the bottom wall 30.

Preferably, all of the walls of the cover 20 and the bottom wall 30 of the tray 22 are formed as solid members so that the enclosure completely encompasses an article mounted therein to protect the article from the surrounding environment. However, it is possible within the scope of the present invention to construct any or all of the walls of the cover 20 with a bottom wall 30 of the tray 22 from partially or fully apertured panels, such as conventional wire screen or mesh sheets.

Fasteners, such as the bolts shown in FIG. 4, extend through apertures in the bottom wall 30 for attachment to a cantilever arm or platform projecting from the vehicle attachment 14. This removably mounts the tray 22 on the vehicle attachment 14.

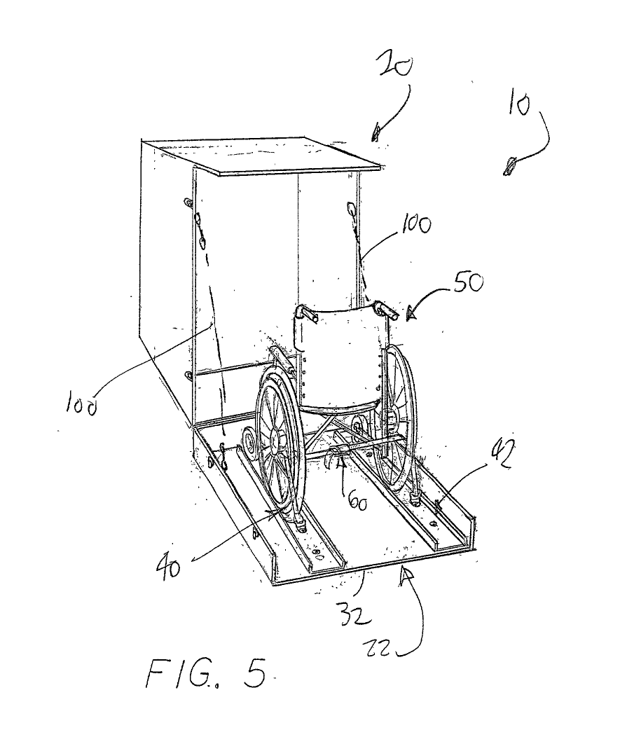

For example only, the vehicle attachment 14 has a manually operated or motor powered drive to elevate the arm and the attached tray 22 between a first elevated or raised, vehicle movable position shown in FIG. 1 and second, lowered, article loading and unloading position shown in FIGS. 3 and 5. An example of such a powered is a lift sold by Renfroematics as the Rise & Ride, serial no. A:4175.

At least one or more vehicle wheel receivers 40 and 42, for example only, are mounted on the bottom wall 30 between the sidewalls 34, 36 and 38. The number and width of each vehicle receiver 40 and 42 is selected to accommodate the particular article which is to be carried in the article carrier 10. For example, manually operated or powered wheelchairs 50, as shown in FIG. 5, have aligned pairs of front and rear wheels. Thus, two vehicle receivers 40 and 42, each in a form of channel-shaped tracks are mounted on the bottom wall 30 by means of the fasteners, such as nuts and bolts, etc.

In the particular example of the tracks 40 and 42 shown FIGS. 3-5, each track 40 and 42 has a center, planar wall 52 and two angularly projecting, generally perpendicularly oriented sidewalls 54 and 56. The fasteners used to attach each track 40 and 42 to the bottom wall 30 extend through apertures formed in the bottom wall 52 of each track 40 and 42.

Although the tracks 40 and 42 are described and illustrated as being removably mountable on the bottom wall 30 of the tray 22, it is also possible within the scope of the present invention to fixedly and non-removably attach the tracks to the bottom wall 30, such as by welding. Alternately, depending the material used to form the tray 22, the tracks 40 and 42 could be integrally formed, such as by molding, casting, etc., directly in the bottom wall 30 in the form of shallow depressions or recesses in the bottom wall 30.

Generally, the tracks 40 and 42 are arranged in parallel. If the spacing between the front wheels of an article, such as a wheelchair 50, is smaller than the space in between the rear wheels, the width of each track 40 and 42 between the sidewalls 54 and 56 can be widened to accommodate one front and one rear wheel.

One, two, three or more tracks, such as tracks 40 and 42 may be mounted on the bottom wall 30 of the tray 22 when the entire article carrier 10 is configured for receiving a bicycle or motorcycle, or a three wheeled stroller or carriage, etc.

As shown in FIGS. 3-5, the article carrier 10 of the present invention uniquely includes at least one and, preferably, a pair of article tie downs 60. In a simple aspect which will be understood to be an example only, the tie down 60 are in the form of conventional vehicle seat belts having two belts 62 and 64. Each belt 62 and 64 has one end attached by means of an eye or collar to one of the fasteners used to attach the tracks 40 and 42 to the bottom wall 30 of the tray 22. The other end of each belt 62 and 64 includes a tongue 66 or a clasp 68 which are releasably engagable. At least one of the ends of the belts 62 and 64 may be pulled through the clasp 68, for example, to lengthen or shorten the joined tie down 60 after the belts 62 and 64 have been passed through intervening portions of an article mounted on the tracks 40 and 42 as shown in FIG. 5 and described hereafter.

The cover 20 of the enclosure 12 is a multi-sided body having four sidewalls 70, 72, 74 and 76 which are joined at adjacent edges to each other and to a top wall 78. This provides the cover 20 with an open end along edge 80 which is alignable and engagable with the uppermost edge of each of the sidewalls 34, 36, and 38 of the tray 22 when the cover 20 is moved to a closed position covering the tray 22 as shown in FIG. 1.

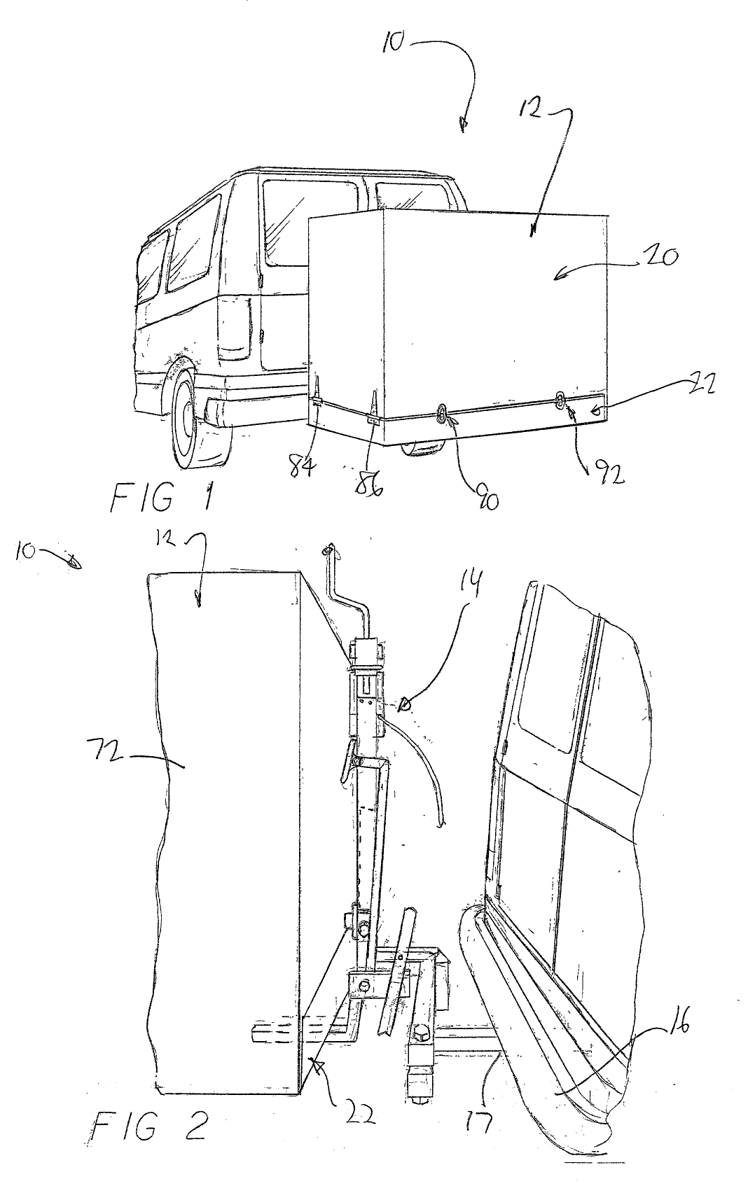

The sidewall 72 of the cover 70 is formed with a longer length then the adjoining sidewalls 72, 74 and 76, as shown in FIG. 2. This allows the end portion of the sidewall 72 to fit between the spaced ends of the sidewalls 34 and 38 of the tray 22 and to abut the end 32 of the bottom wall 30 of the tray 22 when the cover 20 is in the closed position shown in FIG. 1.

The cover 20 is movably connected to the tray 22, preferably by a hinge means formed of a single continuous hinge extending between adjoining edges of the sidewall 76 of the cover 20 and the sidewall 36 of the tray 22 or a plurality of separate hinges, such as the leaf hinges 84 and 86 shown in FIG. 1.

Regardless of its construction, the hinge means, such as the hinges 84 and 86, allows the cover 20 to be pivoted between the first closed position shown in FIG. 1 in which the cover 20 overlays and encloses the interior of the tray 22 to encompass an article mounted on the tray 22 and to a second, open position, spaced from the tray 22, as shown in FIGS. 3 and 5. The second or open position allows easy loading and unloading of an article to and from the tray 22 as well as attachment and release of the article tie down(s) 60.

Latch members 90 and 92, such as interconnectable latches or clasps, have mating portions mounted on the sidewall 70 of the cover 20 and the side edge 34 of the tray 22. The clasps 90 and 92 are releasably engagable to lock the cover 20 to the tray 22 in the first closed position.

In use, assuming that the article carrier 10 is empty and has been lowered to the first vehicle loading and unloading position shown in FIGS. 3 and 5, the clasp 90 and 92 are released and the cover 20 pivoted to the open position shown in FIGS. 3 and 5. An article, such as the wheelchair 50, is then rolled over the edge 32 of the bottom wall 30 into the tracks 40 and 42 until it is positioned generally centrally between opposed ends of the tracks 40 and 42 for even weight distribution purposes. If the particular article mounted on the tray 22 does not have an equal weight distribution between its wheels, the article can be positioned so that its center of gravity is substantially aligned with the support arm on the lift 14 which is attached to the longitudinal center of the tray 22.

With the article, such as the wheelchair 50 appropriately positioned on the tracks 40 and 42, the tie down(s) 60 are separated and each portion, such as belts 60 and 62, are interwoven through adjacent openings in the wheelchair frame or wheels and securely joined together by interconnection of the tongue 66 with the clasp 68. The free end of the belt 62 is then pulled in a direction to tighten the tie down 60 securely across the article or wheelchair 50. This tightening and tie down operation is repeated for each vehicle tie down 60.

When the article or vehicle 50 is securely tied down on the tray 22, the cover 20 is pivoted about the hinges 84 and 86 back to the first closed position shown in FIG. 1. The latches or clasps 90 and 92 are then engaged to lock the cover 20 to the tray 22. The lift 14 is then engaged, manually or via supplying power to a motor on the lift 14, to raise the entire article carrier enclosure 12 to the elevated shown in FIG. 1.

As shown in FIGS. 3, 4, and 5, the cover 20 is provided with optional, but preferred, pivotal movement limiting means or stop members 100. The movement limit or stop members 100, at least one of which is provided, may take a variety of forms, such as chains or springs 100 releasably attached at opposed ends to mounts or pins on an inside surface of the cover 20 and on an inner surface of the sidewalls of the tray 22. Alternately, small diameter, gas assist shock absorbers may be mounted between the cover 20 and the tray 22 to provide a powered lift as well as a cover opening limit.

The stop members 100 limit the movement of the cover 20 relative to the tray 22 to a maximum angular amount, such as approximately 90° as shown in FIG. 3. For further angular movement, one or both ends of the stop members 100 can be removed from the cover 20 and/or the tray 22 to enable the cover 20 to be moved to a further angular position or completely separated from the tray 22 as described hereafter.

Although not shown in FIGS. 3-5, temporary use wheels, in the form of small casters, rollers or wheels, may be mountable on any of the walls or edges of the cover 20 to facilitate easy movement of the cover 20 when separated from the tray 22. Wheel mounts, not shown, may be attached to the outer surface of the sidewalls of the cover 20 or on any exterior surface of the sidewalls of the cover 20. The small wheels, casters or rollers may be stored in the tray 22 or in temporary mounts on the inside surface of the cover 20 and snapped in or otherwise mounted in the external mounts so that the wheels extend below at least one surface or edge of the cover 20 to provide easy rolling movement of the cover 20 on the ground.

In addition to the limit stops described above, a power drive means, such as motor drive jack screw(s) may be mounted between the tray 22 and the cover 20 to facilitate an automatic, powered movement of the cover 20 relative to the tray 22 between the first and second or open or closed positions. Electric power for the drive motor can be obtained from the powered lift 14 and controlled by a switch on the lift 14 or from a remote control, hand held transmitter.

It is also possible to apply powered tie downs in the form of pivotal or movable clamp members which can be moved into an engagement position with respect to the article mounted on the tray 22. The clamps can be moved by an electric motor or other power means carried on the tray 22.

Further, illuminatable lights or passive reflectors, also not shown, may be mounted on the exterior of the cover 20, such as on the rearward facing sidewall 70 to provide a warning to approaching vehicles of the existence of the enclosure 12. Electric power for the illuminatable lights can be obtained from the power lift 14.

Instead of the power lift 14 which is used to raise and lower the entire enclosure 12 for loading and unloading, the enclosure 12 formed of the cover 20 and tray 22, can be mounted as a unit on a conventional, scooter or wheelchair vehicle attachment, not shown, which has a stationary, horizontally extending platform, typically formed of wire mesh. The tray 22 will fit on or in the platform. Such a platform can be provided with a pivotal ramp along one edge which will open to the open edge 32 of the bottom wall 30 of the tray 22 to enable easy loading and unloading of the article to and from the enclosure 12 despite the elevation of the platform and the tray 22 above the ground. The ramp may be permanently pivotally attached to the platform or provided as a separate attachable member.

The article carrier of the present invention may also be employed for other article carrying applications. For example, the tray 22 may be separated from the lift 14 and the cover 20 and used in the interior of a van to support a wheelchair or other article within the interior of the passenger compartment of the van. The tray 22 may be fixedly secured to the van floor by means of fasteners similar to those employed to attach the tray 22 to the vehicle lift 14.

In addition, the hinges 84 and 86 used to pivotally attach the cover 20 to the tray 22 may be constructed with a removable pin thereby enabling the hinge sections to be separated from each other upon removal of the pin. This enables the entire cover 20 to be separated from the tray 22 for loading and unloading oversized articles on the tray 22 or for use of the tray 22 separate from the cover 20 as described above.

In summary, there has been disclosed a unique article carrier mounted on a rear attachment for a vehicle which enables articles, such as movable wheelchairs, bicycles, motorcycles, strollers, baby carriages and other human transport vehicles, to be easily loaded and unloaded on the vehicle for transport between various locations. The article carrier is formed of weather resistant material for long reliable use. The unique article tie downs in the carrier ensure that the articles in the carrier are held in a stationary position during movement of the vehicle. The tray of the article enclosure may be reconfigured as necessary to support a variety of diverse articles having different wheel arrangements.

What is claimed is:

1. An article carrier mountable on a rear vehicle attachment, the article carrier comprising:
an enclosure for receiving an article, the enclosure including:
a tray adapted to be mounted on the vehicle attachment, the tray formed of a bottom wall and having a one side edge; and
a cover movably attached to the tray bottom wall, the cover formed of a closed body completely covering the tray when in a first closed position and movable to a second position exposing the entire bottom wall of the enclosure for article loading and unloading.

2. The article carrier of claim 1 further comprising:
at least one tie down member mountable on the tray for securing an article in a stationary substantially non-movable position on the tray.

3. The article carrier of claim 1 wherein the tray further comprises:
a sidewall extending from the bottom wall separate from the side edge of the bottom wall.

4. The article carrier of claim 3 wherein:
the bottom wall includes four edges, the sidewall extending from three of the edges.

5. The article carrier of claim 1 wherein:
the cover is pivotally attached to the bottom wall and pivotally movable between the first and second positions.

6. The article carrier of claim 5 wherein the cover is hinged to the tray.

7. The article carrier of claim 6 wherein:
at least one hinge pivotally interconnects the cover to the tray.

8. The article carrier of claim 7 wherein at least one hinge comprises:
co-operable hinge elements carried on each of the cover and the tray; and
an interconnecting member pivotally joining the hinge elements, the interconnecting member being removable from the hinge elements allowing separation of the cover from the tray.

9. The article carrier of claim 5 further comprising:
at least one cover movement limit stop member coupled between the cover and the tray for limiting the movement of the cover relative to the tray.

10. The article carrier of claim 9 wherein the at least one cover movement limit stop member comprises a pair of cover movement limit stop members.

11. The article carrier of claim 9 wherein the at least one cover movement limit stop member comprises:
an elongated member coupled between the cover and the tray.

12. The article carrier of claim 1 further comprising:
latches carried on the cover and the tray to latchably couple the cover to the tray when the cover is in the first closed position.

13. The article carrier of claim 1 further comprising:
at least one article receiving track carried in the tray for receiving a portion of the article therein.

14. The article carrier of claim 13 further comprising:
at least one article tie down affixed to the at least one track, the tie down stationarily fixing an article disposed on the track in a stationary substantially non-movable position.

15. The article carrier of claim 13 wherein:
the track comprises a U-shaped channel member fixed on the bottom wall of the tray.

16. The article carrier of claim 1 further comprising:
at least one cover movement limit stop member coupled between the cover and the tray for limiting the movement of the cover relative to the tray.

17. The article carrier of claim 16 wherein the at least one cover movement limit stop member comprises a pair of cover movement limit stop members.

18. The article carrier of claim 16 wherein the at least one cover movement limit stop member comprises:
an elongated member coupled between the cover and the tray.

19. An article carrier mountable on a rear vehicle attachment, the article carrier comprising:
an enclosure for receiving an article, the enclosure including:
a tray adapted to be mounted on the vehicle attachment, the tray formed of a bottom wall and having a one side edge; and
the vehicle attachment including an elevatable lift adapted to be mounted on a vehicle and connected to the tray, the lift enabling elevational movement of the enclosure relative to the vehicle between a first raised position for vehicle movement and a second lowered, article loading and unloading position.
